(19) United States
(12) Patent Application Publication
(10) Pub. No.: US 2006/0119112 A1
(43) Pub. Date: Jun. 8, 2006

(54) Innovative doorknob structure

(76) Inventor: Ku Long Lin, Taichung (TW)

Correspondence Address: LIBERTY PATENT AND TRADEMARK OFFICE, P.O. BOX 590, TAICHUNG CITY, 400, TW

(21) Appl. No.: 10/995,354

(22) Filed: Nov. 24, 2004

(51) Int. Cl. E05B 3/00

(52) U.S. Cl. 292/336.3

(57) ABSTRACT

An innovated doorknob structure consisting of a main unit, a handle, an arrester plate, a spindle and an elastic member is assembled on one side of a door panel. The handle is capable of being turned and has one end inserted and hinged in the main unit. The arrester plate is assembled on the main unit to arrest the handle, and is engaged with the hinge of the handle, so the handle is capable of turning but not falling off from the main unit. The spindle and the elastic member are assembled to one end of the handle that is located inside the main unit. When the handle is turned, the spindle is pushed away from the handle; thereby one end of the spindle drives another doorknob structure, releasing the engagement between the doorknob and the doorframe to open the door panel. The foregoing configuration is simplified operation of opening a door by turning the handle.

### FIELD OF THE INVENTION

The present invention relates to a doorknob structure, applicable to install on a screen door, a windshield door, etc. Such type of door is mainly used as an inside door without the need of a locking mechanism. But it needs to have an engaging function to keep the door in a closed status and a void it from being opened by accident.

### DESCRIPTION OF THE PRIOR ART

A screen door, a windshield door and such type of inside door generally has doorknobs installed on an indoor panel and an outdoor panel of the door; one of the doorknobs (generally on the indoor side) is further equipped with a protruded member that is freely extendable (or called “the nose” by door manufacturers) and is engaged with an arrestor plate on the doorframe. A user has to disengage the nose from the arrestor plate before trying to open the door from either the indoor or outdoor side.

As shown in FIGS. 1 and 2, there are two ways of operation of an outdoor doorknob 10. One way is to push the door panel open from the outdoor side into the indoor side, by pressing the push key 12 on the doorknob 10, when the push key 12 will drive a spindle 13, and the spindle 13 in turn pushes an engaging member 15 on the other side of the door panel 16, thereby disengaging the engaging member 15 from the arrester plate on the doorframe. After then, the user has to push the handle 14 before trying to open the door by pushing the door panel 16 inside.

Another way of operation of an outdoor doorknob 10 is to pull the door panel outward on the outdoor side. First, the user presses down the push key 12 and pulls the handle 14 in an outward direction, so as to disable the engagement between the door panel 16 and the doorframe, and open the door by pulling the door panel 16 outwardly.

In the foregoing prior art, it takes at least two steps to disengaging the door panel 16 from the doorframe, that is, by pressing the push key 12 and pull the handle 14. That two-step operation is obviously not so convenient, and the mechanism of the doorknob is relatively complicated.

### SUMMARY OF THE INVENTION

In view of the shortcomings of sophisticated construction and inconvenient operation in the prior art of doorknob, the present invention has provided an innovative doorknob structure, using simplified structural configuration and simple operation to allow the user better convenience in operating the doorknob.

To achieve the foregoing objective and function, the present invention consists mainly of a main unit, a handle, an arrester plate, a spindle and an elastic member. Wherein, one end of the handle is inserted through the main unit, and connected in a hinged status with the main unit. The arrester plate serves to arrest the handle and engage the handle in a hinged configuration; thereby the handle produces a leverage action when it is subjected to a turning force. The spindle and the elastic member are assembled to one end of the handle. When the handle is turned, the spindle can simultaneously move away from the handle, thereby driving a mechanism on the other doorknob to disengage the doorknob from the arrester plate, before trying to pull the door panel outwardly.

### BRIEF DESCRIPTION OF DRAWINGS

In order that the present invention may more readily be understood, the following description is given, merely by way of example with reference to the accompanying drawings, in which:

FIG. 1 is a first schematic view of the prior art

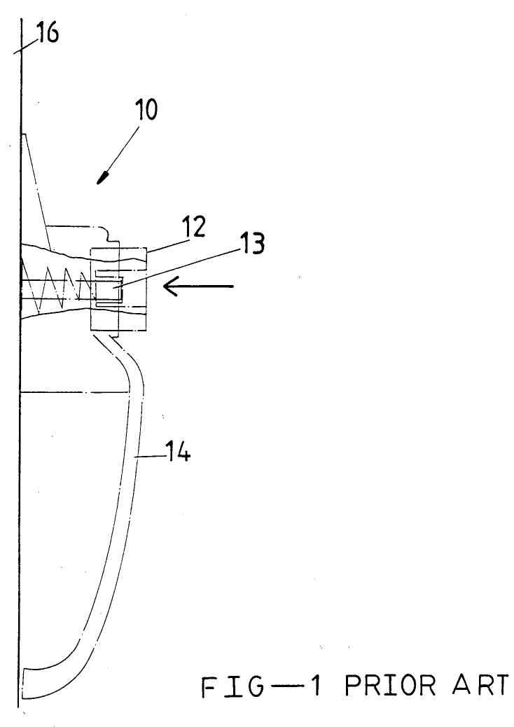

FIG. 2 is a second schematic view of the prior art.

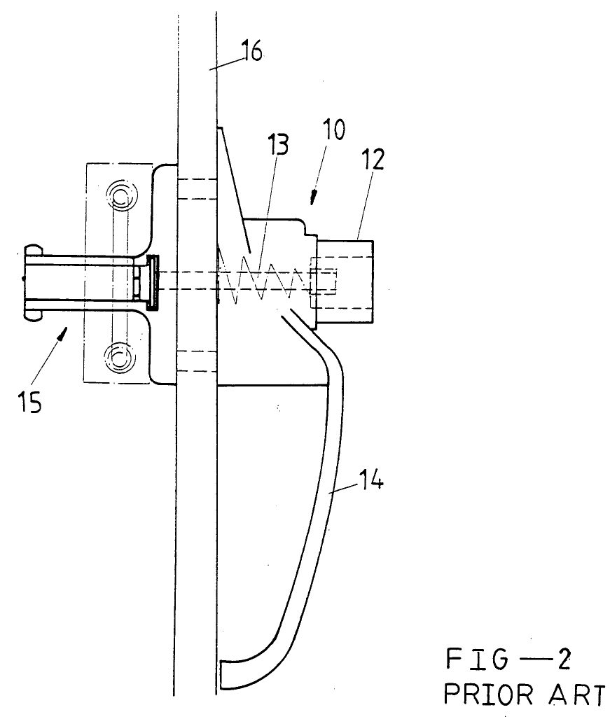

FIG. 3 is an exploded view of the present invention.

FIG. 4 is a partially exploded view showing the assembling process.

FIG. 5 is a schematic view of the assembly of the invention.

FIG. 6 is a schematic view of the assembly in application.

FIG. 7 is a schematic view of the invention before operation.

FIG. 8 is a fist schematic view of the invention in operation.

FIG. 9 is a second schematic view of the invention in operation.

### DESCRIPTION OF THE PREFERRED EMBODIMENT

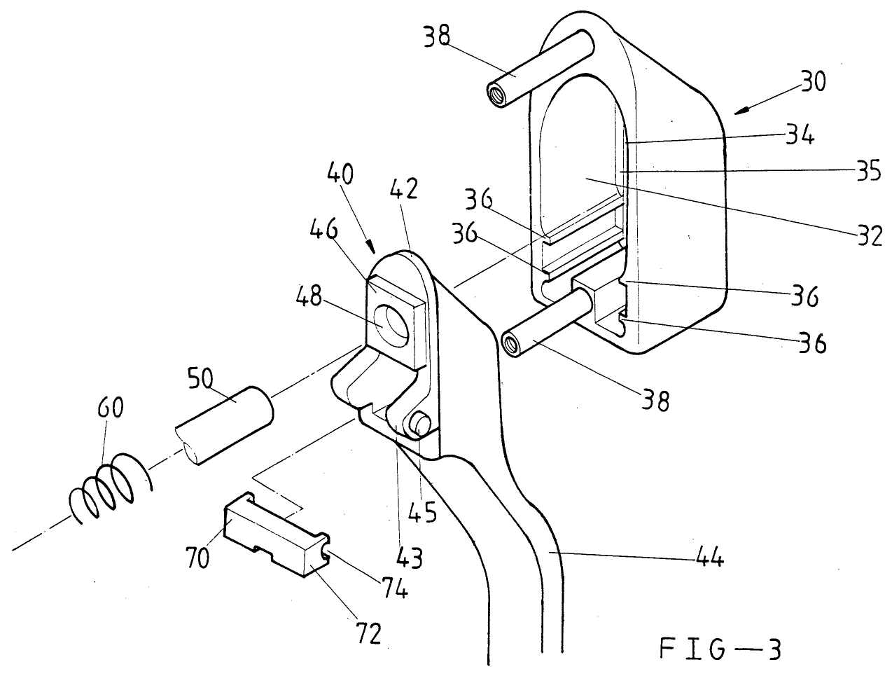

Please refer to FIG. 3; the present invention of doorknob structure includes a main unit 30, a handle unit 40, an arrester plate 70, a spindle 50 and an elastic member 60. The main unit 30 has a hollow interior and an opening 32, 34 on each of two sides thereof, the opening 32 having a larger diameter than that of the other opening 34; the opening 34 having a formation of an arrester margin 35. Provided inside the main unit 30 with two sets of transverse levers 36, the transverse levers 36 being parallel and opposite each other on the inside wall. Two locking rods 38 are protruded from the main unit 30; each of the locking rods 38 has a threaded hole along their axis.

The handle unit 40 includes an arrester part 42 and a handle part 44. The handle part 44 is shaped like a crank and fastened on one side of the arrester part 42. The arrester part 42 has a surface provided with a protruded block 46; the surface of the protruded block 46 is provided with an accommodating hole 48. The accommodating hole 48 is a tapered hole with a larger outer diameter and a smaller inner diameter. Provided on the front side of the arrester part 42 also with a lever part 43; the lever part 43 is formed as one unit with the arrester part 42. On the surface of the lever part 43 provided with a hinge 45. The spindle 50 is an elongated shaft unit. The elastic member 60 has a circular or cone shape, serving to hitch the spindle 50. The arrester plate 70 is a U-shaped structure, having a recess 74 on each of two wall sides 72 thereof.

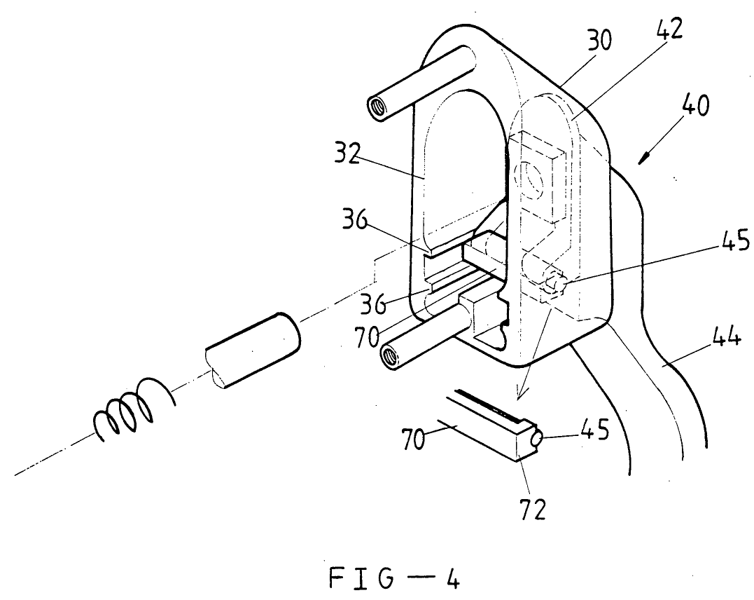

Please refer to FIG. 4 that shows how the invention is assembled. First, the handle part 44 of the handle unit 40 is pulled through the opening 32 to another opening 34 (not shown in drawing) of the main unit 30, so the arrester part 42 is pressed against the arrester margin (not shown in drawing), so designed that the handle unit 40 is arrested by the configuration formed by the arrester part 42 and the arrester margin within the frame of the main unit 30. The arrester plate 70 is assembled onto the main unit 30, fitted to the lower part of the arrester part 42 of the handle unit 40.

Importantly, the hinge 45 provided on the handle unit 40 is located between the two sets of transverse levers 36. When the arrester plate 70 is assembled onto the main unit 30, the hinge 45 is squarely fitted into the recess 74. Thereby, the handle unit 40 is arrested by the arrester plate 70 without the risk of falling off; and, the handle unit 40 is capable of being turned to move because of the engagement of the hinge 45 with the recess 74.

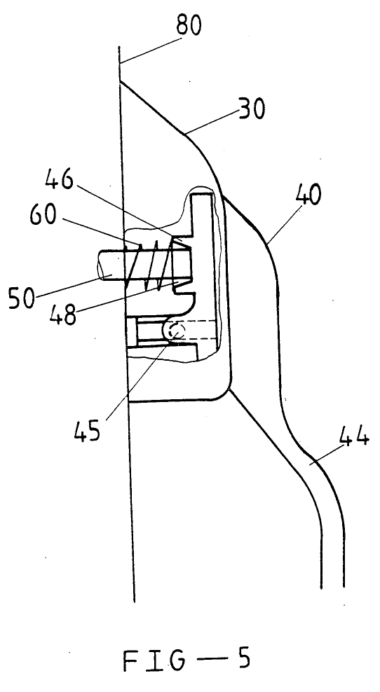

Please refer to FIG. 5. The spindle 50 and the elastic member 60 are assembled by inserting one end of the spindle 50 into the accommodating hole 48 of the protruded block 46. Another end of the spindle 50 is then pulled through a door panel 80 and assembled with a door handle or an engaging component (not shown in drawing). Then, the elastic member 60 is trapped between the door panel 80 and the accommodating hole 48. Finally, the main unit 30 is fastened onto the surface of the door panel 80 using other proper tightening components, such as tightening screws.

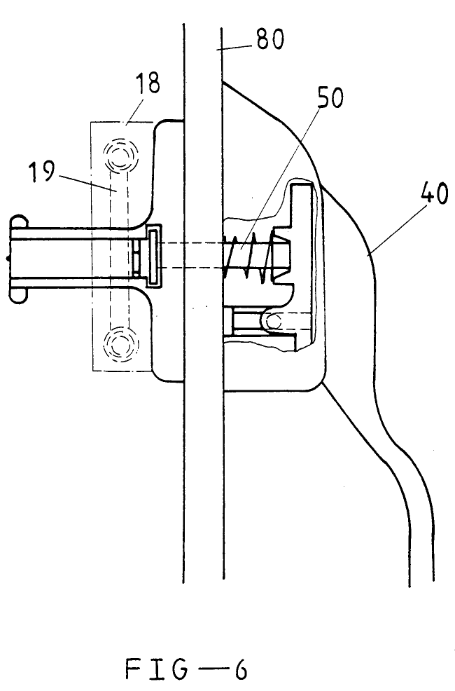

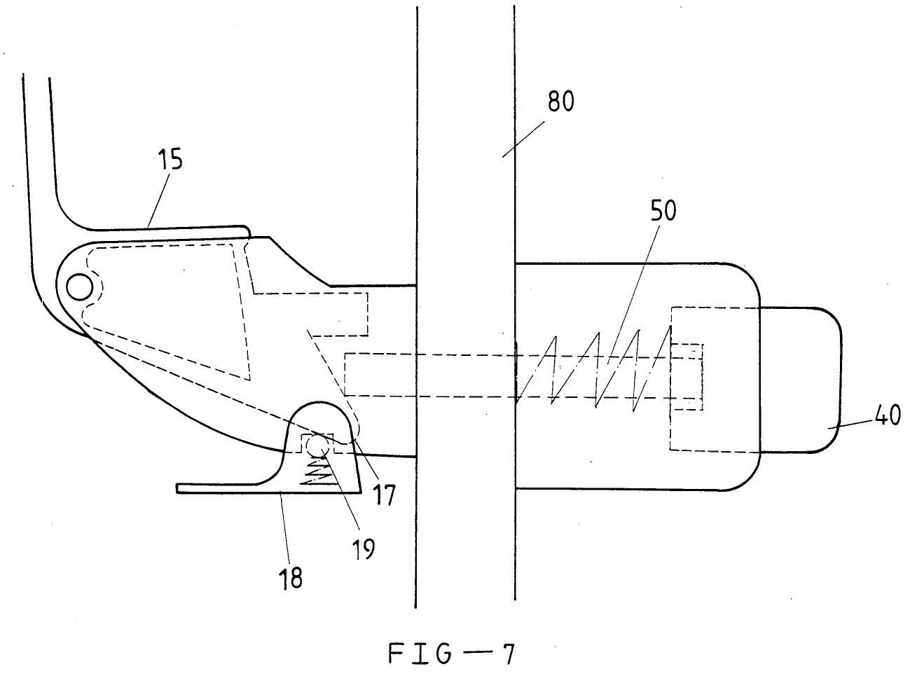

Please refer to FIGS. 6 and 7 that illustrates the application of the invention. An engaging member 15 is installed on the other side of the door panel 80. The engaging member 15 is driven by the handle unit 40 and the spindle 50 to move simultaneously. In a state of engagement, an engaging part 17 of the engaging member 15 is pressing against an engaging rod 19 on an arrester plate 18 on the doorframe.

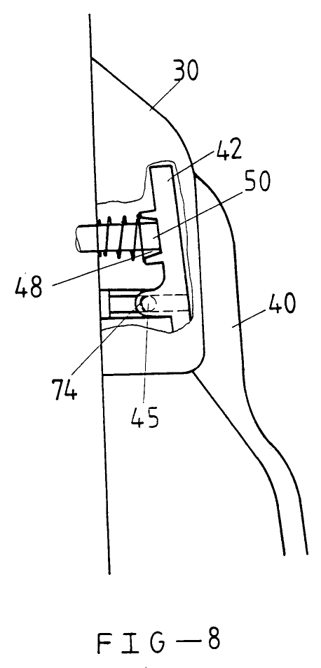

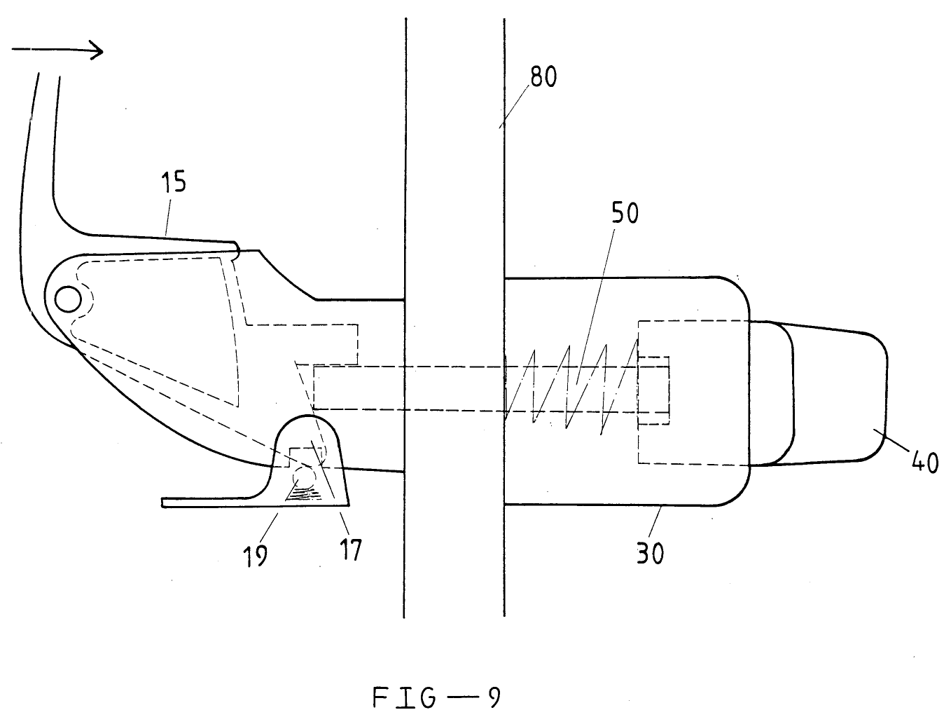

Please refer to FIGS. 8 and 9. When a user pulls the handle unit 40 in a direction away from the door panel 80, the handle unit 40 swings on the assembly of the hinge 45 and the recess 74 as a fulcrum. Then, the arrester part 42 swings to the inside of the main unit 30, moving the spindle 50 away from the main unit 30. At this stage, the spindle 50 is capable of pushing a doorknob mechanism or the engaging member 15 on the other side of the door panel 80, and the engaging part 17 of the engaging member 15 in turn pushes the engaging rod 19, thereby separating the engaging part 17 from the engaging rod 19. Then the user is capable of pulling the door panel 80 in an open status.

The accommodating hole 48 is designed to have a space larger than the outer diameter of the spindle 50, so that when the spindle 50 moves in relation to the arrester part 42, the spindle 50 is capable of free movement, and the handle unit 40 to be turned freely.

It is obvious from the foregoing description that, the present invention comprises only a few components, including the main unit 30, the handle unit 40, the spindle 50, the arrester plate 70 and the elastic member 60. Using only a small quantity of components, the invention is assembled to become a simplified construction. In operation, mere pulling out the handle (44) part will be able to disable the engagement between the doorknob and the doorframe, and opening the door panel 80 simultaneously in a simple and convenient operation.

While particular embodiment of the present invention has been illustrated and described, it would be obvious to those skilled in the art that various other changes and modifications can be made without departing from the spirit and scope of the invention. It is therefore intended to cover in the appended claims all such changes and modifications that are within the scope of the present invention.

1. An innovative doorknob structure, assembled on a side of a door panel, providing a function of opening a door, comprising:
a main unit, assembled on one side of the door panel, having a connecting part;
a handle unit, having a lever part, the lever part having a hinge;
an arrester plate, having recesses on opposite walls, assembled on the main unit to arrest the handle, the recesses being mounted by the hinge of the handle unit;
a spindle, assembled to one end of the handle, capable of synchronous movement with the handle;
an elastic member, mounted outside the spindle, providing resilient force to the handle after the handle swung to one side.
By means turning the handle, the spindle is pushed away from the handle; thereby one end of the spindle drives another doorknob structure, releasing the engagement between the doorknob and the doorframe to open the door panel.

2. The innovative doorknob structure of claim 1, wherein, there are two sets of transverse levers between opposite walls inside the main unit, the hinge of the handle being assembled between the transverse levers.

3. The innovative doorknob structure of claim 1, wherein, one end of the handle is an arrester part, another end of the handle being a lever part, the lever part being installed at the arrester part, to the effect that, after the hinge of the lever part is assembled to the recesses of the arrester plate, an upper part of the arrester part and the lever part become two ends of a lever.

4. The innovative doorknob structure of claim 1, wherein, the one end of the handle has an arrester part, on one side of the arrester part being a protruded block, on one side of the protruded block being an accommodating hole to accommodate assembly of one end of the spindle.

5. The innovative doorknob structure of claim 4, wherein, the accommodating hole has a diameter larger than an outer diameter of the spindle, the accommodating hole being tapered to have a larger outer diameter and a smaller inner diameter.
